(19) United States
(12) Patent Application Publication
(10) Pub. No.: US 2013/0249689 A1
(43) Pub. Date: Sep. 26, 2013

(54) INTELLIGENT WATERING CAN

(71) Applicants: Micael Gustafsson, Malmo (SE); Philip Stankovski, Lund (SE); Frode Thorsén, Malmo (SE)

(72) Inventors: Micael Gustafsson, Malmo (SE); Philip Stankovski, Lund (SE); Frode Thorsén, Malmo (SE)

(73) Assignee: PORTABLE AXXELERATED MEDIA SWEDEN AB, Lund (SE)

(21) Appl. No.: 13/881,730

(22) PCT Filed: Oct. 26, 2011
(86) PCT No.: PCT/SE2011/000188

§ 371 Date: Jun. 3, 2013

(30) Foreign Application Priority Data
Oct. 26, 2010 (SE) SE1001052-8

(51) Int. Cl. A01G 25/14; G08B 21/24

(52) U.S. Cl. CPC A01G 25/14; G08B 21/24
USPC 340/539.22; 222/23; 222/39

(57) ABSTRACT

The invention relates to a watering can for watering of plants and flowers comprising a reservoir (4) for storing water and a handle (1), said reservoir (4) having an inlet hole (3), and an outlet spout (5). The watering can is characterized in that it further comprises a time assessment device (24), a motion sensor (25), and communication means (23, 28). The invention further relates to a method to alert a watering can user that the can has not been used for a certain time period. The method comprises the steps of: starting said time assessment (24) device, checking if said motion sensor (25) has detected motion, and resetting the time assessment device (24) in the case of detected motion, triggering the communication means (23, 28) to communicate when the time assessment device (24) has reached a first pre-determined time assessment.

### TECHNICAL FIELD

The present invention relates generally to an intelligent water can. More particularly, the present invention relates to an intelligent water can as defined in the introductory parts of claim 1.

### BACKGROUND ART

Traditionally watering of plant have been a chore in the household that you have to remember if the plants of the household are to survive. Many plant owners water their plant once or twice a week, depending on the climate and the kind of plants. Normally a traditional watering can capable of storing a couple of liters of water is used.

It is, however, not uncommon to forget to water the plants, which will lead to that some plants will be damage or even die. One way to remember to water the plants is to set an alarm in a calendar or in a mobile phone. This is however inconvenient since the reminder will have to be changed if the plants are watered at any other time than the time of the alarm. If e.g. a user water the plant an extra time before a trip, the alarm would have to be adjusted from that moment, which is easy to forget and inconvenient. Most people, however, do not set an alarm to water their plants increasing the risk to forget to water them.

When a plant owner by mistake forget watering his/her plants, leading to that some or all of the plants die, the user will have to buy new plants. Buying new plants can be very expensive and is a waste of resources. The trip to the plant store will also often lead to an unnecessary environmental load, since the plant owner often will take the car or the bus to the store. The procedure of buying new plants will naturally also take up a lot of time for the plant owner that could otherwise be used for something else.

### SUMMARY OF THE INVENTION

It is an object of the present invention to improve the current state of the art, to solve the above problems, and to provide an improved device for watering of plants. These and other objects are achieved by a watering can for watering of plants and flowers comprising a reservoir for storing water and a handle, the reservoir having an inlet hole, and an outlet spout. The watering can further comprises a time assessment device, a motion sensor, and communication means.

The inventive and intelligent watering can makes life easier for plant owners and helps them to not forget to water the plants. The watering can will use the communication means to communicate to the user when it has not been used for a certain time. The time assessment device will trigger the communication device to communicate this to the user when a certain time has passed since the motion sensor last indicated that the can was moved. In that way the user will not forget to water his/her plants. This may save a certain share of all plants to die from dehydration. The plant owner will save time and money by not having to replace dead plants. Another likely target group that often forget to water their plants are offices, where the watering can according to the present invention will save many plants.

The watering can may be small, having a reservoir volume of 0.2 to 2 liters for indoor use for watering small plants but may as well have a reservoir volume of 2-20 liters or more for outdoor use.

It is further possible, in a different embodiment of the present invention, to use the watering can according to the present invention for professional use, e.g. at a farm or at a zoo. In a farm the reservoir may be even bigger and could e.g. have wheels attached and a connection device so that it may be pulled by a tractor. The farmer will be notified when a certain field needs to be watered.

The motion sensor may be any sensor that can indicate if the watering can moves. The motion sensor can be of any common type as e.g. a piezo-electrical motion sensor, but could also be an optical sensor with a light source and a detector.

It is further preferred that the watering can comprises an electric circuit connected to the time assessment device, the motion sensor and the communication means. The electric circuit will connect time assessment devices that are electrical and not mechanical with electrical motion sensors and electrical communication means.

It should however be noted that all of these components could be non-electrical. The motion sensor and time assessment de could be a pipe in which a body moves easily to one end when the watering can is used and takes a long time to fall back when not used, eventually falling down on the communication means, which could be a bell. The reason for the slow return of the body could e.g. be that it comes in contact with water when the watering can is used, and swells.

The watering can further preferably comprises an energy source. The energy source may be any kind of battery or fuel cell. The battery preferably delivers a voltage suitable for the attached electrical components.

It is further preferred that the time assessment device is a clock. The clock can be implemented as a timer to trigger the communication device when the timer expires. It is also preferred that the communication means is a loudspeaker. When the time assessment device trigger the loudspeaker, the loudspeaker receives an electrical current, making the loudspeaker play sounds in accordance with the amplitude variations of the current.

The communication means could however also be a light source as a LED, emitting light when the time assessment device indicate that it is time to use the watering can.

According to a preferred embodiment of the present invention the electric circuit comprises a CPU and a memory, said CPU being adapted to execute algorithms stored on the memory. The algorithms are preferably computer programs that control the components that are connected to the electrical circuit. The computer programs may contain logic such as timer programs, scheduling and control programs for connected equipment. The memory may comprise sound information adapted to be communicated via said loudspeaker. The sound information could be stored in any common sound format playable by the CPU using the loudspeaker, e.g. wave, mp3, etc.

According to a further embodiment, the communication means of the watering can is a radio transmitter or radio transceiver. It may e.g. be a phone module adapted to communicate via at least one mobile phone network standard, as e.g. the GSM, CDMA, or LTE standards. The phone module could e.g. call the owner of the watering can playing a recorded message reminding the owner about the time period since the last watering session. The phone module could also send an SMS or an MMS to the user with a text reminding the owner to water his/her plants.

The radio transceiver could also be a Bluetooth module able to communicate with other equipment in the house. The device could e.g. tell the owners Bluetooth equipped mobile phone to show the owner a reminder message, when sensing that the specific phone is home and within range. It could also communicate with equipment in an intelligent house, as e.g. a house control computer or a home multimedia computer. The possibilities for reminding the owner is then up to the computer, but could include anything from playing sounds, controlling lamps, light effects, showing a message on the TV, sending an email, etc.

It is further preferred that the watering can according to the invention has an input/output port (I/O-port), as, e.g. a USB or firewire port. The I/O-port may e.g. be used to ad or change the sounds or tunes that the watering can uses to, via the loudspeaker, remind the user to water his/her plants. The port could also be used to charge the battery of the watering can if the watering can is of model that has a battery that is rechargeable.

The operation of the watering can according to the invention will now shortly be described. The time assessment device, or timer, is started and time is measured until the motion sensor detects motion or a first pre-determined time has elapsed according to the assessment of the time assessment device. If the motion sensor has detected motion, and the watering can thus can be assumed to have been used, the time assessment device, or timer, is reset. If, on the other hand, the first pre-determined time has elapsed, the watering can will activate the communication means to communicate to the user that the watering can has not been used for a long time. The means of communication can be any of the previously described types, e.g. a tune that is played by a loudspeaker.

It is further preferred that the loop described above is repeated for a second pre-determined time until the user notice and make use of the watering can. That is, the timer is reset, and if the motion sensor does not detect any motion for some time, the second pre-determined time period, the watering can will again activate the communication means and e.g. play a tune.

The first and second pre-determined time periods are e.g. 72 hours and 5 minutes respectively. They can be fixed in manufacturing or made possible to adjust for the user.

### BRIEF DESCRIPTION OF THE DRAWINGS

The above objects, as well as additional objects, features and advantages of the present invention, will be more fully appreciated by reference to the following illustrative and non-limiting detailed description of preferred embodiments of the present invention, when taken in conjunction with the accompanying drawings, wherein:

FIG. 1 is a cross sectional view of the watering can according to the invention.

FIG. 2 is a diagram of electronics contained in a preferred embodiment of the watering can according to the invention.

FIG. 3 is a diagram showing a method according to the present invention.

### DETAILED DESCRIPTION OF PREFERRED EMBODIMENTS OF THE INVENTION

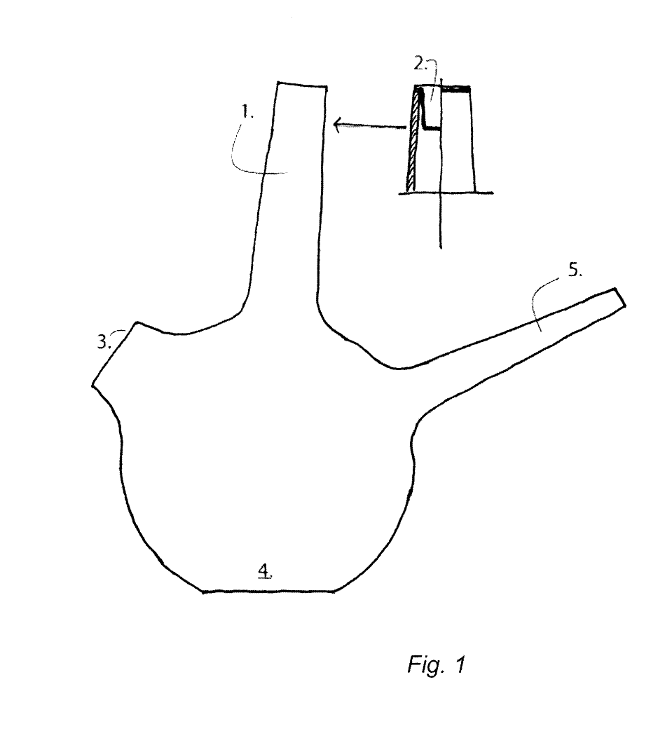

The watering can is comprised of five important parts, as shown in FIG. 1. A handle 1 is connected to a container 4 for water. The watering can has one inlet hole 3 and one spout 5 for outlet of water. The handle contains a casing that holds out water that contain the electronics 2 the electronics of the watering can.

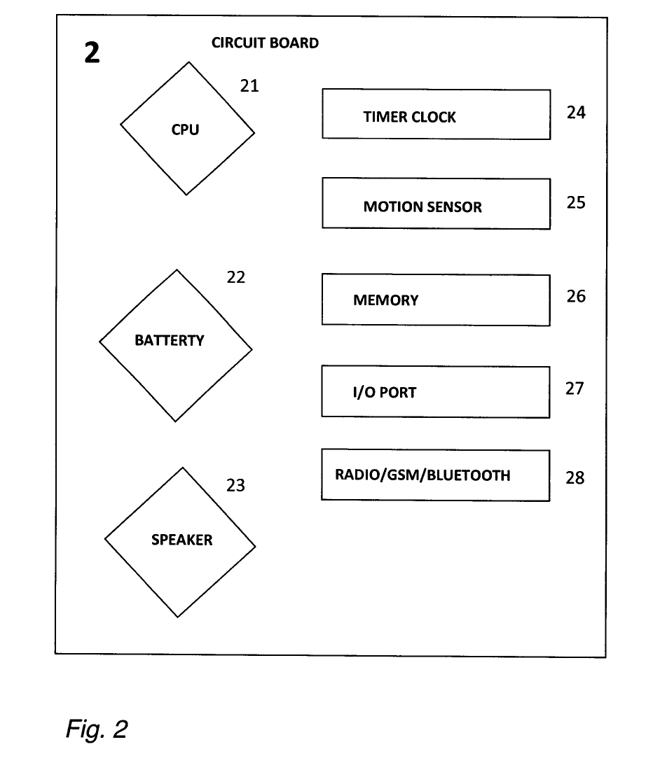

FIG. 2 shows a preferred embodiment of the electronics 2 of the watering can. The electronics board contains a timer clock 24, being the time assessment device, a motion sensor 25, a CPU 21, a battery 22 and a speaker 23, the speaker being the communication device. The preferred embodiment also has some optional components, not necessarily included I all models of the product according to the invention, namely an input/output (I/O) port 27 and a radio communication component 28.

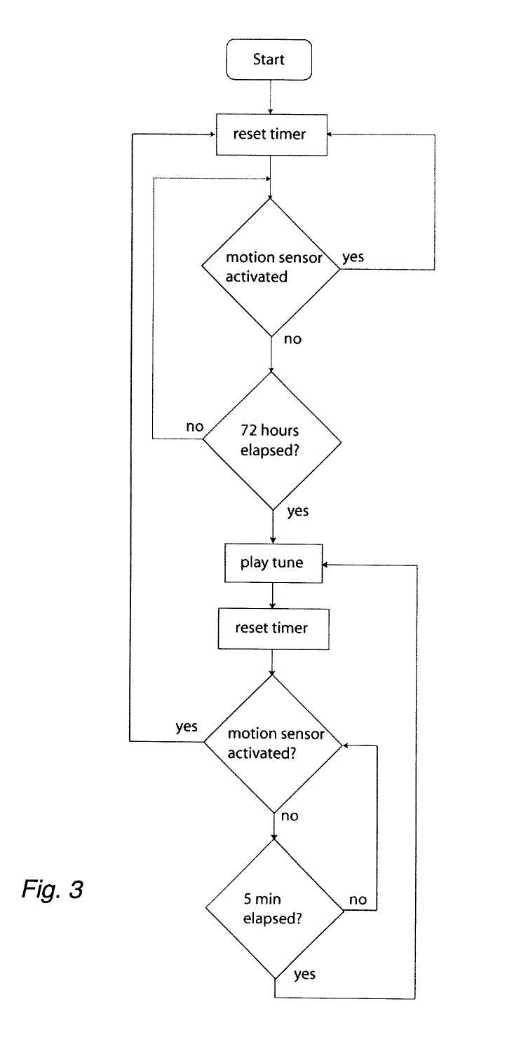

FIG. 3 shows a flowchart of the function of an embodiment according to the present invention. When tuning the device on, the first thing that happens is that the timer is reset and starts to measure time, having a pre-determined set off time, e.g. 72 h. During that time the timer can be reset at any point if the watering can is moved so that the motion sensor is activated. Unless the motion sensor detects movement in the pre-determined time, e.g. 72 h, the timer will set of and the CPU will execute a tune to be played to remind the watering can owner to water his/her plants. When the tune is played, the timer is once again reset, but to a second predetermined time, e.g. 5 minutes. If the owner of the watering can hasn't set of the motion sensor, by moving the watering can, within the second predetermined time, the tune will be played again and the timer will be reset to the second predetermined time once again. If on the other hand, the motion sensor is set off, indicating that the watering can has been used, the function of the watering can will start over by resetting the timer to the first predetermined time of, e.g. 72 h.

If the watering can has the optional I/O-port 27, the watering can may be recharged via the port. It is preferably a standard connection like a mini-USB connection for example. Tunes stored in the memory could also be accessed and replaced through the I/O port, 27 e.g. by connecting the watering can to a computer.

If the watering can has the optional radio component 28, the steps in FIG. 3 where the tune is played are complemented by sending a radio signal from the radio component. The radio component 28 could be a Bluetooth device communicating to another device, e.g. a computer, to send a reminder to the user in any form. The radio component 28 could also be a mobile phone component, able to either call the user and play a recorded message that is stored on the memory, or send a text or image message to the users mobile phone. The voice, text and/or image message to the user and the telephone number or numbers that are to be called are stored on the memory 28 and are edited either via the I/O port, if existing, or via text message over the telephone network or by accessing the watering can via Bluetooth from a Bluetooth enabled device.

It is understood that other variations in the present invention are contemplated and in some instances, some features of the invention can be employed without a corresponding use of other features. It is thus understood that the reservoir of the watering may have any practically useful shape and any size, and that the device may be used for all kinds of watering assignments. The assignments could vary from watering plants in your home, watering plants at a farm, watering/feeding plants or bacteria in scientific labs etc, etc. Accordingly, it is appropriate that the appended claims be construed broadly in a manner consistent with the scope of the invention.

1. Watering can for watering of plants and flowers comprising
a reservoir (4) for storing water and a handle (1),
said reservoir (4) having an inlet hole (3), and an outlet spout (5),
characterized in that said watering can further comprises
a time assessment device (24),
a motion sensor (25), and
communication means (23, 28).

2. Watering can according to claim 1, further comprising an electric circuit (2) connected to the time assessment device (24), the motion sensor (25) and the communication means (23, 28).

3. Watering can according to claim 1, further comprising an energy source (22).

4. Watering can according to claim 1, wherein the communication means is a loudspeaker (23).

5. Watering can according to claim 1, wherein the time assessment device (24) is a clock.

6. Watering can according to claim 1, wherein the time assessment device (24) is a timer.

7. Watering can according to claim 1, wherein an electric circuit comprises a CPU (21) and a memory (26), said CPU being adapted to execute algorithms stored on said memory.

8. Watering can according to claim 4, wherein an electric circuit comprises a CPU (21) and a memory (26), said CPU being adapted to execute algorithms stored on said memory; said memory (26) comprises sound information adapted to be communicated via said loudspeaker (23).

9. Watering can according to claim 1, wherein the communication means (28) is a radio transmitter or radio transceiver.

10. Watering can according to claim 1, wherein the communication means (28) is a phone module adapted to communicate via at least one mobile phone network standard.

11. Method to alert a watering can user that the can has not been used for a certain time period, said watering can comprising a reservoir (4) for storing water, and a handle (1), said reservoir having an inlet hole (3), an outlet spout (5), said watering can further comprising a time assessment device (24), a motion sensor (25), and communication means (23, 28),
said method comprising the steps of:
starting said time assessment (24) device,
checking if said motion sensor (25) has detected motion, and resetting the time assessment device (24) in the case of detected motion,
triggering the communication means (23, 28) to communicate when the time assessment device (24) has reached a first pre-determined time assessment.

12. Method according to claim 11, further comprising the steps of:
resetting the time assessment device (24) after the time assessment device has reached a first pre-determined time assessment,
checking if said motion sensor (25) has detected motion, and resetting the time assessment device (24) in the case of detected motion,
triggering the communication means (23, 28) to communicate when the time assessment device has reached a second pre-determined time assessment.

13. Watering can according to claim 4, wherein an electric circuit comprises a CPU (21) and a memory (26), said CPU being adapted to execute algorithms stored on said memory.
